(19) United States
(12) Patent Application Publication
(10) Pub. No.: US 2017/0370583 A1
(43) Pub. Date: Dec. 28, 2017

(54) Ceramic Matrix Composite Component for a Gas Turbine Engine

(71) Applicant: General Electric Company, Schenectady, NY (US)

(72) Inventors: Mark Willard Marusko, Springboro, OH (US); Mark Eugene Noe, West Chester, OH (US); Darrell Glenn Senile, Oxford, OH (US)

(21) Appl. No.: 15/189,044

(22) Filed: Jun. 22, 2016

(51) Int. Cl. F23R 3/00; C04B 35/64; C04B 35/71; C04B 35/622

(52) U.S. Cl. CPC F23R 3/007; F23R 3/002; C04B 35/62218; C04B 35/64; C04B 35/71

(57) ABSTRACT

Ceramic matrix composite (CMC) components and methods for forming CMC components of gas turbine engines are provided. In one embodiment, a CMC component for a gas turbine engine includes an inner wall defining a first inner surface; an outer wall defining a second inner surface; and a nozzle extending from the inner wall to the outer wall. The inner wall, outer wall, and nozzle are integrally formed from a CMC material such that the inner wall, outer wall, and nozzle are a single unitary component. An exemplary method for forming a CMC component includes laying up a plurality of plies of a CMC material; processing the plurality of plies to form a green state component; firing the green state component; and densifying the fired component to produce a final unitary component. The unitary component comprises a combustor liner portion and a combustor discharge nozzle stage portion.

### FEDERALLY SPONSORED RESEARCH

This invention was made with government support under contact number FA8650-07-C-2802 of the United States Air Force. The government may have certain rights in the invention.

### FIELD OF THE INVENTION

The present subject matter relates generally to ceramic matrix composite components and, more particularly, to ceramic matrix composite components for gas turbine engines.

### BACKGROUND OF THE INVENTION

A gas turbine engine generally includes a fan and a core arranged in flow communication with one another. Additionally, the core of the gas turbine engine general includes, in serial flow order, a compressor section, a combustion section, a turbine section, and an exhaust section. In operation, air is provided from the fan to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gases through the turbine section drives the turbine section and is then routed through the exhaust section, e.g., to atmosphere.

Typically, the gas turbine engine includes a combustor having a combustion chamber defined by a combustor liner. The combustor liner includes an inner liner wall and an outer liner wall. Immediately downstream of the combustor is a turbine nozzle stage, including stationary guide vanes, stator vanes, etc., provided to direct therethrough the flow of combustion gases from the combustion section. The turbine nozzle stage usually includes a plurality of circumferentially spaced turbine nozzle sections. Similar to the combustor liner, each nozzle section usually has an inner endwall and an outer endwall, with a nozzle extending therebetween. Thus, typical gas turbine engines utilize a combustor liner that is separate from the turbine nozzle sections immediately downstream of the combustor, requiring multiple seals between the liner and nozzle stage to attempt to control parasitic leakage between the combustor and first turbine nozzle stage. The seals and their associate hardware add weight and complexity to the engine, which can negatively engine performance and assembly.

In addition, non-traditional high temperature materials, such as ceramic matrix composite (CMC) materials, are more commonly being used for various components within gas turbine engines. For example, because CMC materials can withstand relatively extreme temperatures, there is particular interest in replacing components within the flow path of the combustion gases with CMC materials. Combustor liners and turbine nozzle stages each have surfaces and/or features exposed to or within the flow path of the combustion gases.

Accordingly, a combustor and turbine nozzle stage assembly that essentially eliminates the need for sealing without adding unnecessary weight or complexity would be desirable. For example, an integral combustor liner and turbine nozzle stage, which eliminates the need for sealing between the liner and the nozzle stage, would be beneficial. In particular, an integral CMC combustor liner and turbine nozzle stage, i.e., a combustor liner and turbine nozzle stage integrally formed from a CMC material, would be advantageous. A method for forming an integral CMC combustor liner and turbine nozzle stage also would be useful.

### BRIEF DESCRIPTION OF THE INVENTION

Aspects and advantages of the invention will be set forth in part in the following description, or may be obvious from the description, or may be learned through practice of the invention.

In one exemplary embodiment of the present disclosure, a ceramic matrix composite component for a gas turbine engine is provided. The ceramic matrix composite component includes an inner wall defining a first inner surface; an outer wall defining a second inner surface; and a nozzle extending from the inner wall to the outer wall. The inner wall, outer wall, and nozzle are integrally formed from a ceramic matrix composite material such that the inner wall, outer wall, and nozzle are a single unitary component.

In another exemplary embodiment of the present disclosure, a method is provided for forming a ceramic matrix composite component of a gas turbine engine. The method includes laying up a plurality of plies of a ceramic matrix composite material; processing the plurality of plies to form a green state component; firing the green state component; and densifying the fired component to produce a final unitary component. The unitary component comprises a combustor liner portion and a combustor discharge nozzle stage portion.

In one exemplary aspect of the present disclosure, a method is provided for forming a ceramic matrix composite component of a gas turbine engine. The method includes laying up a plurality of plies of a ceramic matrix composite material; processing the plurality of plies to form a green state component; firing the green state component; and densifying the fired component to produce a final unitary component. Laying up the plurality of plies comprises interspersing a plurality of combustor liner plies with a plurality of combustor discharge nozzle stage plies. Further, the unitary component comprises an inner wall and an outer wall, and the inner and outer wall define a combustion chamber adjacent a forward end of the unitary component. The unitary component also comprises a nozzle extending from the inner wall to outer wall adjacent an aft end of the unitary component.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic cross-sectional view of an exemplary gas turbine engine according to various embodiments of the present subject matter.

FIG. 2 is a close-up, side view of a combustion section and a turbine section of the exemplary gas turbine engine of FIG. 1.

FIG. 3A is a schematic view of a plurality of CMC plies of an integral combustor liner and combustor discharge nozzle stage in accordance with an exemplary embodiment of the present disclosure.

FIG. 3B is a schematic view of interspersed CMC plies of an integral combustor liner and combustor discharge nozzle stage in accordance with an exemplary embodiment of the present disclosure.

FIG. 3C is a schematic view of an integral combustor liner and combustor discharge nozzle stage after firing and densification in accordance with an exemplary embodiment of the present disclosure.

FIG. 4 is a flow diagram of a method for forming an integral combustor liner and combustor discharge nozzle stage in accordance with an exemplary embodiment of the present disclosure.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

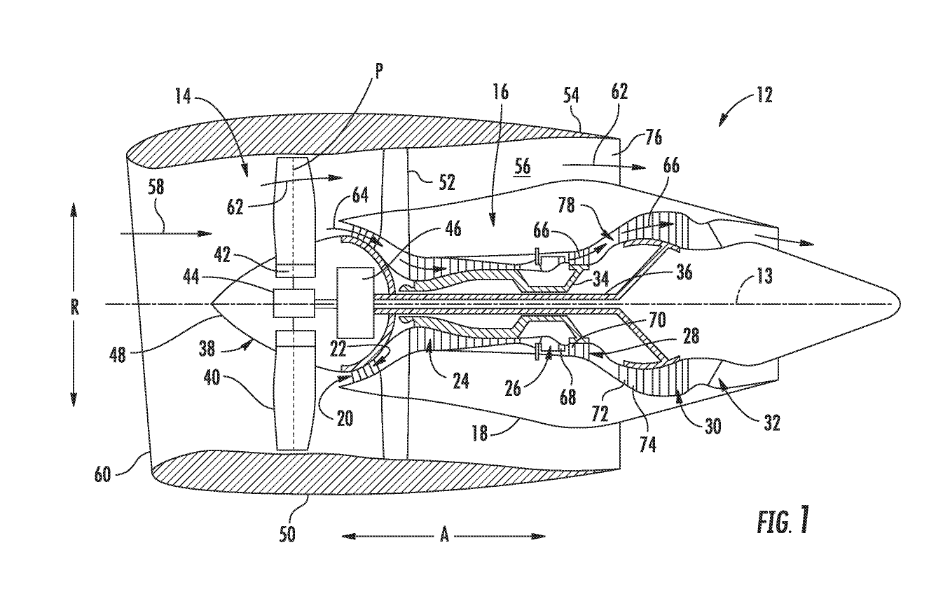

Referring now to the drawings, wherein identical numerals indicate the same elements throughout the figures, FIG. 1 is a schematic cross-sectional view of a turbomachine in accordance with an exemplary embodiment of the present disclosure. More particularly, for the embodiment of FIG. 1, the turbomachine is configured as a gas turbine engine, or rather as a high-bypass turbofan jet engine 12, referred to herein as “turbofan engine 12.” As shown in FIG. 1, the turbofan engine 12 defines an axial direction A (extending parallel to a longitudinal centerline 13 provided for reference), a radial direction R, and a circumferential direction C (extending about the longitudinal centerline 13) extending about the axial direction A. In general, the turbofan 10 includes a fan section 14 and a core turbine engine 16 disposed downstream from the fan section 14.

The exemplary core turbine engine 16 depicted generally includes a substantially tubular outer casing 18 that defines an annular inlet 20. The outer casing 18 encases and the core turbine engine 16 includes, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft or spool 34 drivingly connects the HP turbine 28 to the HP compressor 24. A low pressure (LP) shaft or spool 36 drivingly connects the LP turbine 30 to the LP compressor 22. Accordingly, the LP shaft 36 and HP shaft 34 are each rotary components, rotating about the axial direction A during operation of the turbofan engine 12.

Referring still to the embodiment of FIG. 1, the fan section 14 includes a variable pitch fan 38 having a plurality of fan blades 40 coupled to a disk 42 in a spaced apart manner. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable pitch change mechanism 44 configured to collectively vary the pitch of the fan blades 40 in unison. The fan blades 40, disk 42, and pitch change mechanism 44 are together rotatable about the longitudinal axis 12 by LP shaft 36 across a power gear box 46. The power gear box 46 includes a plurality of gears for adjusting the rotational speed of the fan 38 relative to the LP shaft 36 to a more efficient rotational fan speed. More particularly, the fan section includes a fan shaft rotatable by the LP shaft 36 across the power gearbox 46. Accordingly, the fan shaft may also be considered a rotary component, and is similarly supported by one or more bearings.

Referring still to the exemplary embodiment of FIG. 1, the disk 42 is covered by a rotatable front hub 48 aerodynamically contoured to promote an airflow through the plurality of fan blades 40. Additionally, the exemplary fan section 14 includes an annular fan casing or outer nacelle 50 that circumferentially surrounds the fan 38 and/or at least a portion of the core turbine engine 16. The exemplary nacelle 50 is supported relative to the core turbine engine 16 by a plurality of circumferentially-spaced outlet guide vanes 52. Moreover, a downstream section 54 of the nacelle 50 extends over an outer portion of the core turbine engine 16 so as to define a bypass airflow passage 56 therebetween.

During operation of the turbofan engine 12, a volume of air 58 enters the turbofan 10 through an associated inlet 60 of the nacelle 50 and/or fan section 14. As the volume of air 58 passes across the fan blades 40, a first portion of the air 58 as indicated by arrows 62 is directed or routed into the bypass airflow passage 56 and a second portion of the air 58 as indicated by arrow 64 is directed or routed into the core air flowpath 37, or more specifically into the LP compressor 22. The ratio between the first portion of air 62 and the second portion of air 64 is commonly known as a bypass ratio. The pressure of the second portion of air 64 is then increased as it is routed through the high pressure (HP) compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft or spool 34, thus causing the HP shaft or spool 34 to rotate, thereby supporting operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft or spool 36, thus causing the LP shaft or spool 36 to rotate, thereby supporting operation of the LP compressor 22 and/or rotation of the fan 38.

The combustion gases 66 are subsequently routed through the jet exhaust nozzle section 32 of the core turbine engine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the turbofan 10, also providing propulsive thrust. The HP turbine 28, the LP turbine 30, and the jet exhaust nozzle section 32 at least partially define a hot gas path 78 for routing the combustion gases 66 through the core turbine engine 16.

In some embodiments, components of turbofan engine 12, particularly components within hot gas path 78, may comprise a ceramic matrix composite (CMC) material, which is a non-metallic material having high temperature capability. Exemplary CMC materials utilized for such components may include silicon carbide, silicon, silica, or alumina matrix materials and combinations thereof. Ceramic fibers may be embedded within the matrix, such as oxidation stable reinforcing fibers including monofilaments like sapphire and silicon carbide (e.g., Textron's SCS-6), as well as rovings and yarn including silicon carbide (e.g., Nippon Carbon's NICALON®, Ube Industries' TYRANNO®, and Dow Corning's SYLRAIVIIC®), alumina silicates (e.g., Nextel's 440 and 480), and chopped whiskers and fibers (e.g., Nextel's 440 and SAFFIL®), and optionally ceramic particles (e.g., oxides of Si, Al, Zr, Y, and combinations thereof) and inorganic fillers (e.g., pyrophyllite, wollastonite, mica, talc, kyanite, and montmorillonite). As further examples, the CMC materials may also include silicon carbide (SiC) or carbon fiber cloth.

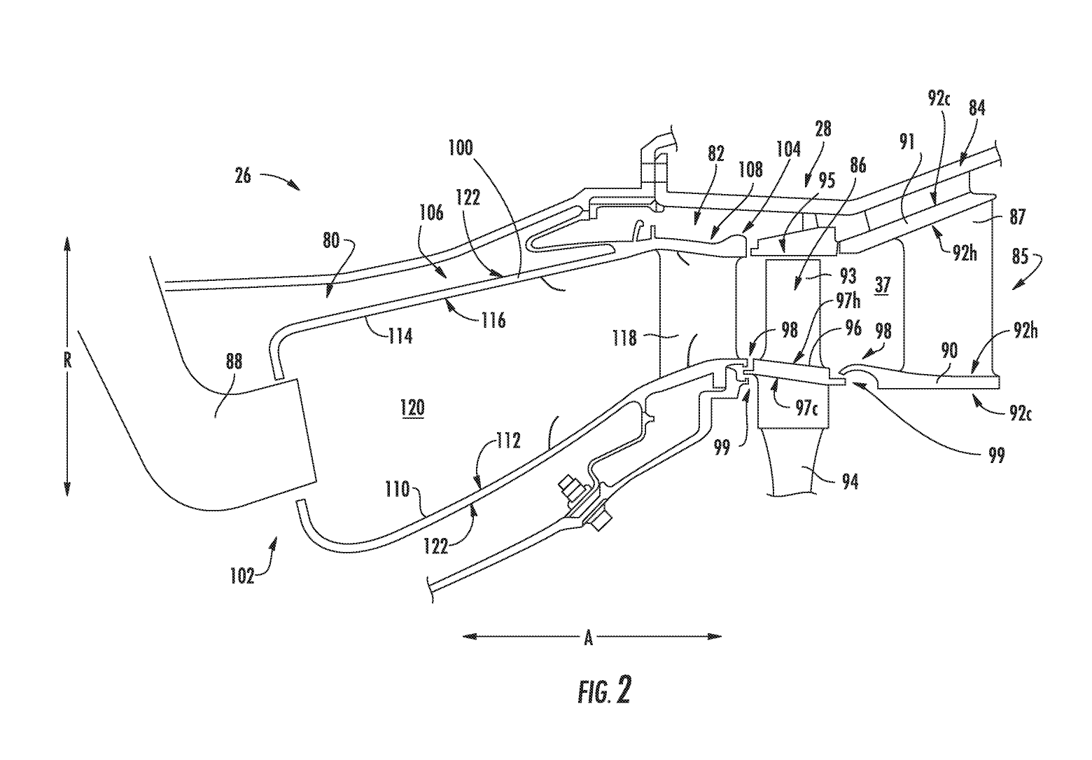

Referring now to FIG. 2, a close-up, cross-sectional view is provided of the turbofan engine 12 of FIG. 1 and particularly of the combustion section 26 and the HP turbine 28 of the turbine section. The depicted combustion section 26 generally includes an annular combustor 80, and downstream of the combustion section 26, the HP turbine 28 includes a plurality of turbine component stages. Each turbine component stage comprises a plurality of turbine components. More particularly, for the depicted embodiment, HP turbine 28 includes a plurality of turbine nozzle stages, such as first and second turbine nozzle stages 82, 84 shown in FIG. 2, as well as one or more stages of turbine rotor blades, such as turbine rotor blade stage 86.

Typically, the combustor includes a combustion chamber defined by a combustor liner having an inner liner wall and an outer liner wall, and the HP turbine includes a first turbine nozzle stage located immediately downstream from the combustion section, such that the first turbine nozzle stage also may be referred to as a combustor discharge nozzle stage. The combustor discharge nozzle stage usually includes a plurality of circumferentially spaced turbine nozzle sections. Each nozzle section includes an inner endwall and an outer endwall, with a nozzle extending generally radially from the inner endwall to the outer endwall. Thus, typical turbofan engines utilize a combustor liner that is separate from the turbine nozzle sections immediately downstream of the combustor.

However, as illustrated in FIG. 2, turbofan engine 12 includes an integral combustor liner and combustor discharge nozzle stage 100. The integral combustor liner and combustor discharge nozzle stage 100 depicted in FIG. 2 has a forward end 102 and an aft end 104. A combustor liner portion 106 is defined adjacent forward end 102, and a combustor discharge nozzle stage portion 108 is defined adjacent aft end 104.

Integral liner and nozzle stage 100 also includes an inner wall 110 defining a first inner surface 112 of integral liner and nozzle stage 100 and an outer wall 114 defining a second inner surface 116 of integral liner and nozzle stage 100. In the depicted embodiment of FIG. 2, outer wall 114 extends generally circumferentially about inner wall 110, i.e., outer wall 114 is spaced radially outward from inner wall 110. A nozzle 118 extends generally radially, i.e., generally along the radial direction R, from inner wall 110 to outer wall 114 within the combustor discharge nozzle stage portion 108. It will be appreciated that, while only one nozzle 118 is depicted in FIG. 2, integral liner and nozzle stage 100 includes a plurality of nozzles 118 spaced generally circumferentially about longitudinal centerline 13 within combustor discharge nozzle stage portion 108. Each nozzle 118 of the plurality of nozzles extends generally radially from inner wall 110 to outer wall 114.

The inner wall 110, outer wall 114, and nozzle 118 are integrally formed from a ceramic matrix composite material such that the inner wall 110, outer wall 114, and nozzle 118 are a single unitary component. More particularly, where integral liner and nozzle stage 100 includes a plurality of nozzles 118, each nozzle 118 is integrally formed with inner wall 110 and outer wall 114 such that inner wall 110, outer wall 114, and the plurality of nozzles 118 are a single unitary component. As such, integral combustor liner and combustor discharge nozzle stage 100 also may be referred to as integral component 100 or unitary component 100. In an exemplary embodiment, integral component 100 is formed from a CMC material. Methods and/or processes for forming an integral combustor liner and combustor discharge nozzle stage 100, particularly an integral CMC combustor liner and combustor discharge nozzle stage, are described in greater detail below.

Further, the term “unitary” as used herein denotes that the associated component, particularly integral combustor liner and combustor discharge nozzle stage 100, is made as a single piece during manufacturing, i.e., the unitary component is a continuous piece of material. Thus, a unitary component has a monolithic construction and is different from a component that has been made from a plurality of component pieces that have been joined together to form a single component. More specifically, in the exemplary embodiment of FIG. 2, inner wall 110, outer wall 114, and nozzle 118 are constructed as a single unit or piece to form unitary component 100.

Referring still to FIG. 2, within combustor liner portion 106 of unitary component 100, inner wall 110 and outer wall 114 define a combustion chamber 120 at or adjacent forward end 102 that extends generally along the axial direction A. Accordingly, a portion 110C of inner wall 110 and a portion 114C of outer wall 114 essentially define a combustor liner and, thus, form combustor liner portion 106 of unitary component 100. At the aft end 104 of unitary component 100, a portion 110N of inner wall 110 and a portion 114N of outer wall 114, with nozzle 118 extending therebetween, essentially define a first nozzle stage of HP turbine 28 and, thus, form combustor discharge nozzle stage 108 of unitary component 100.

A plurality of fuel nozzles 88 are positioned at forward end 102 of unitary component 100 for providing combustion chamber 120 with a mixture of fuel and compressed air from the compressor section. As discussed above, the fuel and air mixture is combusted within the combustion chamber 120 to generate a flow of combustion gases therethrough. As such, first inner surface 112 and second inner surface 116 generally define a hot side of unitary component 100. The hot side is exposed to and defines in part a portion of the core air flowpath 37 extending through combustion chamber 120, as well as combustor discharge nozzle stage portion 108 such that nozzle 118 is positioned within the core air flowpath 37. Opposite the hot side is a cold side 122, and although not depicted, inner wall 110 and/or outer wall 114 may include thermal management features, such as one or more cooling holes extending from the cold side to the hot side, to maintain a temperature of inner wall 110 and/or outer wall 114 within a desired operating temperature range.

Additionally, for the depicted exemplary embodiment of FIG. 2, turbofan engine 12 includes second turbine nozzle stage 84 downstream of integral combustor liner and combustor discharge nozzle stage 100. That is, integral combustor liner and combustor discharge nozzle stage 100 extends from forward end 102 adjacent fuel nozzles 88 to aft end 104 adjacent second turbine nozzle stage 84 such that integral component 100 extends within combustion section 26 and HP turbine section 28. Second turbine nozzle stage 84 includes a plurality of turbine nozzle sections 85 spaced along the circumferential direction C. Each second turbine nozzle section 85 includes a second stage turbine nozzle 87 positioned within the core air flowpath 37, as well as an inner endwall 90 and an outer endwall 91, with the second stage turbine nozzle 87 extending generally along the radial direction R from the inner endwall 90 to the outer endwall 91. The inner endwall 90 and outer endwall 91 of the second nozzle section 85 each define a cold side 92c and an opposite hot side 92h exposed to and at least partially defining the core air flowpath 37.

Located immediately downstream of the unitary component 100 and immediately upstream of the second turbine nozzle stage 84, the HP turbine 28 includes a first stage 86 of turbine rotor blades 93. First stage 86 of turbine rotor blades 93 includes a plurality of turbine rotor blades 93 spaced along the circumferential direction C and a first stage rotor 94. The plurality of turbine rotor blades 93 are attached to first stage rotor 94. Although not depicted, turbine rotor 94 is, in turn, connected to the HP shaft 34 (FIG. 1). In such manner, turbine rotor blades 93 may extract kinetic energy from the flow of combustion gases through the core air flowpath 37 defined by the HP turbine 28 as rotational energy applied to the HP shaft 34. Turbofan engine 12 additionally includes a shroud 95 exposed to and at least partially defining the core air flowpath 37. Further, similar to inner wall 110 and outer wall 114 of unitary component 100 and inner endwall 90 and outer endwall 91 of second turbine nozzle stage 84, each of the turbine rotor blades 93 includes a wall or platform 96. Platform 96 of each of the turbine rotor blades 93 defines a cold side 97c and an opposite hot side 97h exposed to and at least in part defining the core air flowpath 37.

As further illustrated in FIG. 2, aft end 104 of unitary component 100 includes a seal 98, and each turbine nozzle section 85 of second turbine nozzle stage 84 includes a seal 98. Additionally, platform 96 of each turbine rotor blade 93 includes a seal 99. Seals 99 are configured to interact with the seals 98 of discharge nozzle stage portion 108 of unitary component 100 and turbine nozzle sections 85 forming second turbine nozzle stage 84. The interaction of seals 98, 99 helps to prevent an undesired flow of combustion gases from the core air flowpath 37 between the first stage 86 of turbine rotor blades 93 and integral liner and nozzle stage 100, as well as between first turbine blade stage 86 and second turbine nozzle stage 84. However, as shown in FIG. 2, because combustor liner portion 106 is integrally formed with combustor discharge nozzle stage portion 108, no seals are required to prevent undesired leakage of combustion gases between combustor 80 and the first stage 82 of turbine nozzles, i.e., combustor discharge nozzle stage portion 108 of unitary component 100. As such, any leakage between the combustor and first turbine nozzle stage may be essentially eliminated, as well as any weight and complexity attributable to seals or sealing mechanisms that would be used between a combustor liner and combustor discharge nozzle stage when the combustor liner is separate from the combustor discharge nozzle stage.

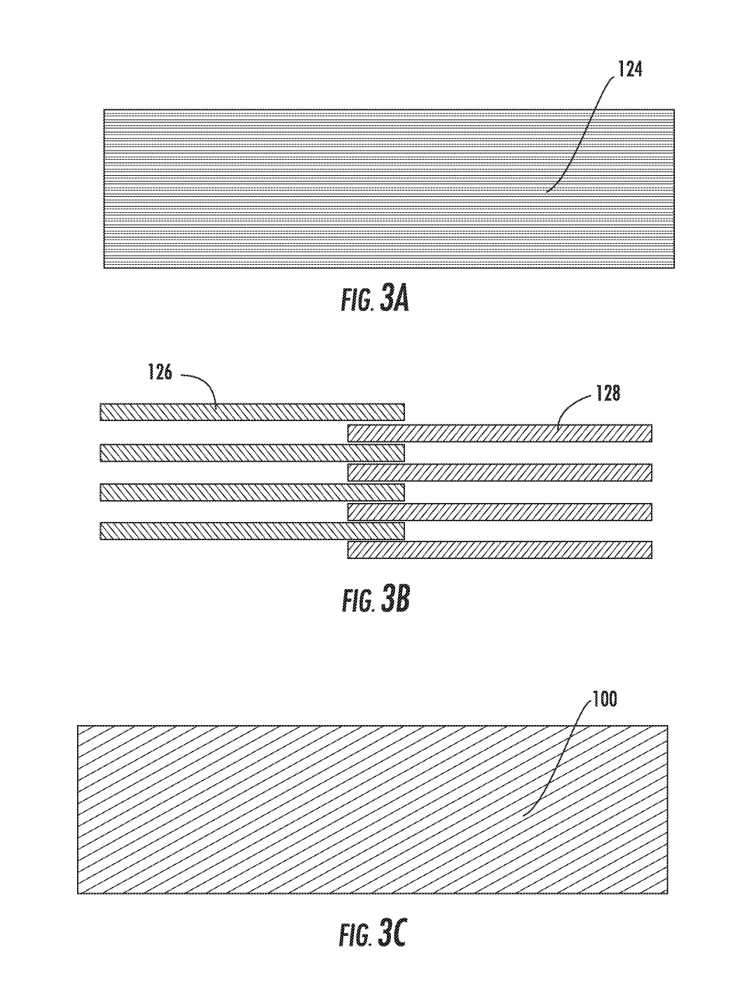

Referring now to the schematic illustrations of FIGS. 3A through 3C, integral combustor liner and combustor discharge nozzle stage 100 will be described in greater detail. Turning to FIG. 3A, a plurality of plies 124 of a CMC material may be used to form the integral component 100. In such embodiments, inner wall 110, outer wall 114, and nozzle 118 are formed from the CMC plies 124. CMC plies 124 may be, e.g., plies pre-impregnated (pre-preg) with matrix material and may be formed from pre-preg tapes or the like. For example, the CMC plies may be formed from a prepreg tape comprising a desired ceramic fiber reinforcement material, one or more precursors of the CMC matrix material, and organic resin binders. According to conventional practice, prepreg tapes can be formed by impregnating the reinforcement material with a slurry that contains the ceramic precursor(s) and binders. The slurry also may contain solvents for the binders that promote the fluidity of the slurry to enable impregnation of the fiber reinforcement material, as well as one or more particulate fillers intended to be present in the ceramic matrix of the CMC component, e.g., silicon and/or SiC powders in the case of a Si—SiC matrix. Preferred materials for the precursor will depend on the particular composition desired for the ceramic matrix of the CMC component. For example, the precursor material may be SiC powder and/or one or more carbon-containing materials if the desired matrix material is SiC; notable carbon-containing materials include carbon black, phenolic resins, and furanic resins, including furfuryl alcohol (C₄H₃OCH₂OH).

As shown schematically in FIG. 3B, the plurality of CMC plies 124 may include a plurality of CMC plies 126 for forming combustor liner portion 106 and a plurality of CMC plies 128 for forming combustor discharge nozzle stage portion 108. Liner plies 126 may include plies for forming inner wall 110C of combustor liner portion 106, as well as plies for forming outer wall 114C of combustor liner portion 106. Similarly, nozzle stage plies 128 may include plies for forming inner wall 110N of combustor discharge nozzle stage portion 108, plies for forming outer wall 114N of combustor discharge nozzle stage portion 108, and plies for forming nozzles 118 of combustor discharge nozzle stage portion 108. As such, nozzle stage plies 128 include plies for forming an inner endwall, an outer endwall, and a plurality of nozzles of a combustor discharge turbine nozzle stage.

In the exemplary embodiment depicted in FIG. 3B, liner plies 126 and nozzle stage plies 128 are interspersed with one another. More specifically, where liner plies 126 meet nozzle stage plies 128, plies 126 are alternated with plies 128 to integrate the plies for forming combustor liner portion 106 with the plies for forming combustor discharge nozzle stage portion 108. That is, any joints between plies 126, 128 may be formed by alternating layers of plies 126, 128. In some embodiments, single plies 126, 128 may be alternated to integrate plies 126 and 128 and thereby integrate combustor liner portion 106 with combustor discharge nozzle stage portion 108. In other embodiments, one or more liner plies 126 may be formed in a stack that is alternated with a stack of one or more nozzle stage plies 128 to integrate plies 126 and 128 and thereby integrate combustor liner portion 106 with combustor discharge nozzle stage portion 108.

Of course, integral combustor liner and combustor discharge nozzle stage 100 may be formed from a plurality of inner wall plies, a plurality of outer wall plies, and a plurality of nozzle plies, each ply made from a CMC material. The inner wall, outer wall, and nozzle plies may be interspersed, e.g., alternated where the plies meet as shown in FIG. 3B, to form integral combustor liner and combustor discharge nozzle stage 100. In this way, the plies forming the combustor liner portion 106 are interspersed, and thereby integrated, with the plies forming the combustor discharge nozzle stage portion 108.

Further, it will be appreciated that any spacing between adjacent plies 126 and adjacent plies 128 shown in FIG. 3B is for purposes of illustration only. For example, in various embodiments, little to no space may be defined between adjacent plies 126 and adjacent plies 128 when plies 126, 128 are laid up during the process of forming the integral combustor liner and combustor discharge nozzle stage 100. Rather, in exemplary embodiments, a ply 126 may be in contact with adjacent plies 126, except where plies 126 are interspersed with plies 128 as described above. Of course, some spacing between adjacent plies 126 and/or adjacent plies 128 may result in the layup of plies 126, 128, but not necessarily to the extent or between every adjacent ply as shown in the schematic representation of FIG. 3B.

Referring now to FIG. 3C, in an exemplary embodiment, the plurality of plies 124 defining inner wall 110, outer wall 114, and nozzle 118 are cured to produce a single piece component 100, then fired and subjected to silicon melt-infiltration to form final unitary component 100. For example, plies 124 may be processed in an autoclave to produce a green state integral liner and discharge nozzle stage 100. Then, green state component 100 may be placed in a furnace with a piece or slab of silicon and fired to melt infiltrate the component 100 with silicon. More particularly, for unitary component 100 formed from CMC plies 124 of prepreg tapes that are produced as described above, heating (i.e., firing) the green state component in a vacuum or inert atmosphere decomposes the binders, removes the solvents, and converts the precursor to the desired ceramic matrix material. The decomposition of the binders results in a porous CMC body; the body may undergo densification, e.g., melt-infiltration (MI), to fill the porosity. In the foregoing example where the green state component is fired with silicon, component 100 undergoes silicon melt-infiltration. The melt-infiltrated CMC body hardens to a final unitary CMC component 100.

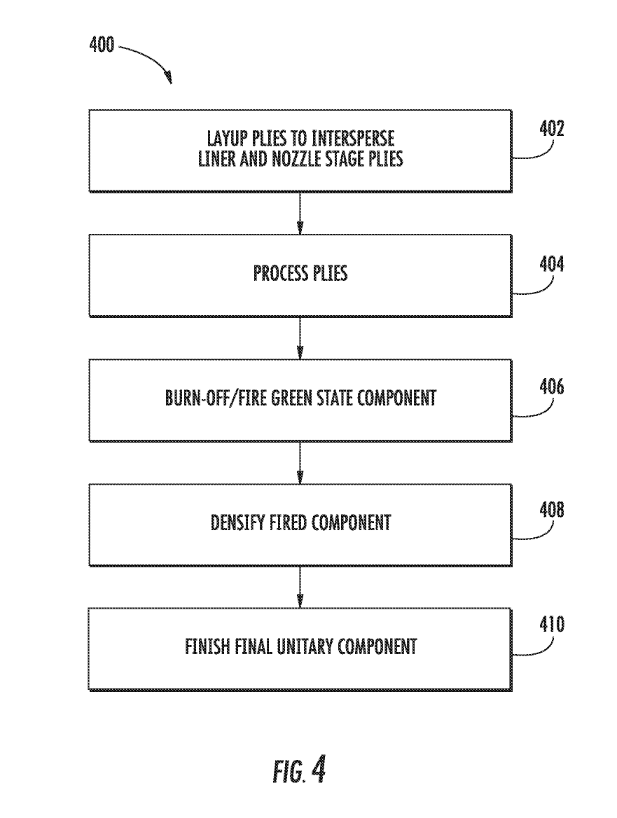

FIG. 4 provides a chart illustrating a method 400 for forming integral combustor liner and combustor discharge nozzle stage 100 according to an exemplary embodiment of the present subject matter. As shown at 402 in FIG. 4, a plurality of plies 124 of a CMC material for forming the unitary component 100 may be laid up to define a desired shape. During the layup generally shown at 402, a desired component shape may be generally defined; the component shape may be finally defined after the plies are processed and machined as needed. Plies 124 may be laid up on a layup tool, mandrel, mold, or other appropriate device for supporting the plies and/or for defining the desired shape. Further, laying up plies 124 may comprise layering liner plies 126 and nozzle stage plies 128, or inner wall, outer wall, and nozzle plies, by alternating layers of plies 126, 128 as previously described. That is, laying up plies 124 may include interspersing liner and nozzle stage plies 126, 128 or inner wall, outer wall, and nozzle plies. Interspersing plies 124 forming combustion liner portion 106 and combustor discharge nozzle stage portion 108 integrates portions 106, 108 such that the resultant component is integral combustor liner and combustor discharge nozzle stage 100.

After the plies 124 are laid up, the plies may be processed, e.g., compacted and cured in an autoclave, as shown at 404 in FIG. 4. After processing, the plies form a green state component 100, i.e., a green state integral liner and nozzle stage 100. Green state component 100 is a single piece component, i.e., curing plies 124 produces a unitary component 100 formed from a continuous piece of CMC material. The green state component 100 then may undergo firing and densification, illustrated at 406 and 408 in FIG. 4, to produce a final unitary component 100. As previously described, the unitary component 100 comprises inner wall 110 and outer wall 114, which define combustor liner portion 106 adjacent the forward end 102 of component 100 and combustor discharge nozzle stage portion 108 adjacent the aft end 104 of component 100. Nozzle 118 extends from inner 110 and outer wall 114 of unitary component 100.

In an exemplary embodiment of method 400, the green state component 100 is placed in a furnace with silicon to burn off any mandrel-forming materials and/or solvents used in forming the CMC plies 124, to decompose binders in the solvents, and to convert a ceramic matrix precursor of the plies into the ceramic material of the matrix of the unitary CMC component 100. The silicon melts and infiltrates any porosity created with the matrix as a result of the decomposition of the binder during burn-off/firing. However, densification may be performed using any known densification technique including, but not limited to, Silcomp, melt-infiltration (MI), chemical vapor infiltration (CVI), polymer infiltration and pyrolysis (PIP), and oxide/oxide processes. In one embodiment, densification and firing may be conducted in a vacuum furnace or an inert atmosphere having an established atmosphere at temperatures above 1200° C. to allow silicon or other appropriate material or materials to melt-infiltrate into the component 100. After firing and densification, as shown at 410 in FIG. 4, the unitary component 100, having combustor liner portion 106 and combustor discharge nozzle stage portion 108, may be finish machined, if and as needed. Additionally or alternatively, an environmental barrier coating (EBC) may be applied to unitary component 100.

Method 400 is provided by way of example only. For example, other processing cycles, e.g., utilizing other known methods or techniques for compacting and/or curing CMC plies, may be used. Further, unitary component 100 may be post-processed or densified using a melt-infiltration process or a chemical vapor infiltration process, or component 100 may be a matrix of pre-ceramic polymer fired to obtain a ceramic matrix. Alternatively, any combinations of these or other known processes may be used as well.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A ceramic matrix composite component for a gas turbine engine, the ceramic matrix composite component comprising:
an inner wall defining a first inner surface;
an outer wall defining a second inner surface; and
a nozzle extending from the inner wall to the outer wall,
wherein the inner wall, outer wall, and nozzle are integrally formed from a ceramic matrix composite material such that the inner wall, outer wall, and nozzle are a single unitary component.

2. The ceramic matrix composite component of claim 1, wherein the unitary component has a forward end and an aft end, and wherein the unitary component includes a combustor liner portion adjacent the forward end and a combustor discharge nozzle stage portion adjacent the aft end.

3. The ceramic matrix composite component of claim 1, wherein the unitary component has a forward end and an aft end, and wherein the inner and outer walls define a combustion chamber adjacent the forward end.

4. The ceramic matrix composite component of claim 1, wherein the inner wall, outer wall, and nozzle are formed from plies of the ceramic matrix composite material.

5. The ceramic matrix composite component of claim 4, wherein plies forming one portion of the unitary component are interspersed with plies forming another portion of the unitary component.

6. The ceramic matrix composite component of claim 5, wherein the plies for forming the one portion of the unitary component are alternated with the plies for the other portion of the unitary component to intersperse the plies.

7. The ceramic matrix composite component of claim 4, wherein the interspersed plies are cured and melt-infiltrated with silicon to form the unitary component.

8. A method for forming a ceramic matrix composite component of a gas turbine engine, the method comprising:
laying up a plurality of plies of a ceramic matrix composite material;
processing the plurality of plies to form a green state component;
firing the green state component; and
densifying the fired component to produce a final unitary component,
wherein the unitary component comprises a combustor liner portion and a combustor discharge nozzle stage portion.

9. The method of claim 8, wherein laying up the plurality of plies includes laying up a plurality of combustor liner plies and a plurality of combustor discharge nozzle stage plies.

10. The method of claim 9, wherein laying up the plurality of plies includes interspersing the combustor liner plies with the combustor discharge nozzle stage plies, wherein interspersing the combustor liner plies with the combustor discharge nozzle stage plies integrates the combustor liner portion and the combustor discharge nozzle stage portion.

11. The method of claim 10, wherein interspersing the combustor liner plies with the combustor discharge nozzle stage plies includes alternating combustor liner plies with combustor discharge nozzle stage plies.

12. The method of claim 9, wherein the plurality of combustor liner plies includes a plurality of plies for forming an inner wall of a combustor liner and a plurality of plies for forming an outer wall of a combustor liner.

13. The method of claim 9, wherein the plurality of combustor discharge nozzle stage plies includes a plurality of plies for forming an inner endwall of a combustor discharge nozzle stage, a plurality of plies for forming an inner endwall of a combustor discharge nozzle stage, and a plurality of plies for forming a plurality of nozzles of a combustor discharge nozzle stage.

14. The method of claim 8, wherein processing the plies includes curing the plies to produce a single piece component.

15. The method of claim 8, wherein densification of the fired component comprises silicon melt-infiltration.

16. The method of claim 8, wherein the unitary component comprises an inner wall and an outer wall.

17. The method of claim 16, wherein the unitary component further comprises a nozzle extending from the inner wall to the outer wall.

18. A method for forming a ceramic matrix composite component of a gas turbine engine, the method comprising:
laying up a plurality of plies of a ceramic matrix composite material, wherein laying up the plurality of plies comprises interspersing a plurality of combustor liner plies with a plurality of combustor discharge nozzle stage plies;
processing the plurality of plies to form a green state component;
firing the green state component; and
densifying the fired component to produce a final unitary component,
wherein the unitary component comprises an inner wall and an outer wall, the inner and outer wall defining a combustion chamber adjacent a forward end of the unitary component, and
wherein the unitary component comprises a nozzle extending from the inner wall to outer wall adjacent an aft end of the unitary component.

19. The method of claim 18, wherein interspersing the combustor liner plies with the combustor discharge nozzle stage plies includes alternating combustor liner plies with combustor discharge nozzle stage plies.

20. The method of claim 18, wherein the plurality of combustor discharge nozzle stage plies includes a plurality of plies for forming an inner endwall of a combustor discharge nozzle stage, a plurality of plies for forming an outer endwall of the combustor discharge nozzle stage, and a plurality of plies for forming a plurality of nozzles of the combustor discharge nozzle stage.
